(19) United States
(12) Patent Application Publication
(10) Pub. No.: US 2009/0300952 A1
(43) Pub. Date: Dec. 10, 2009

(54) FREESTANDING DISPLAY CARD

(76) Inventor: George K.C. Hayes, Missoula, MT (US)

Correspondence Address: Goff Patent Law PLLC, P.O. Box 625, Brush Prairie, WA, 98606, US

(21) Appl. No.: 12/479,078

(22) Filed: Jun. 5, 2009

Related U.S. Application Data
(60) Provisional application No. 61/059,505, filed on Jun. 6, 2008.
(60) Provisional application No. 61/077,374, filed on Jul. 1, 2008.

(51) Int. Cl. G09F 1/04; G09F 1/00; B42D 15/02

(52) U.S. Cl. 40/124.07; 40/124.09; 40/124.01; 229/92.8

(57) ABSTRACT

A freestanding card can include a main display area. The card can also include a base that can hold the main display area in a generally upright position, such as a base including a left leg extending away from a left side of a central lower portion of the card, and a right leg extending away from a right side of the central lower portion of the card. The card can be a unitary card including the main display area and the base. The base may hold the main display area in a concavo-convex shape.

### RELATED APPLICATIONS

This application claims the benefit of U.S. Provisional Application No. 61/059,505, entitled FREESTANDING DISPLAY CARD, filed Jun. 6, 2008, and of U.S. Provisional Application No. 61/077,374, entitled FREESTANDING DISPLAY CARD, filed Jul. 1, 2008, both of which are incorporated herein by reference.

### TECHNICAL FIELD

The description relates generally to display cards, and more particularly to a generally flat freestanding card.

### BACKGROUND

Display cards can take a number of forms, such as postcards and point-of-purchase cards. Postcards are commonly used to display information, which typically takes the form of an image on the front of the card and a handwritten or printed message on the back. For example, postcards may be used to convey personal messages from scenic tourism destinations, to deliver sales messages from businesses to current or prospective individual customers or corporate customers, or as general greeting cards in place of standard foldout greeting cards. Traditionally, postcards for all three of the above uses have consisted of simple flat pieces of cardboard.

Point-of-purchase cards, also known as point-of-sale (POS) cards, are also commonly used to display information, and are typically deployed by retail businesses at the point where a product or service is decided upon or paid for. One common configuration is that of a “table tent” (a folded place card with two equal and sloping sides and a base), most commonly used by restaurants. Typically, a table tent is placed at each customer's table in order to announce menu items and specials; likewise hotels often place table tents on desks and atop televisions in guest rooms. Another common configuration of a POS card is a single printed sheet affixed to a folding cardboard easel.

Various prior patents disclose freestanding cardboard devices that people can mail, and that allow people to insert and display custom photographs. In addition, German patent document number DE20103215U1 to Pawlik (the Pawlik Patent Document) discloses a freestanding postcard made from a single sheet of cardboard with various scores and perforations.

### SUMMARY

The present inventor recognized shortcomings of prior freestanding card displays. For example, the freestanding cardboard devices for inserting, mailing, and displaying photographs require relatively complex structures, typically with multiple layers of cardboard, which would be difficult to manufacture. In addition, the configuration of scores and perforations in many of those structures, and in the cards disclosed in the Pawlik Patent Document present problems in assembly, mailing, and graphic design.

Furthermore, cardboard table tent point-of-sale displays often require folding at the point of manufacture, and then further folding and assembly at the point of sale. Such table tent displays often require that both sloping sides be printed, although often only one side is visible to customers. Another display device comprises a printed sheet affixed to a folding cardboard easel, which can be relatively expensive. Yet another display system comprises a printed sheet inserted into an L-shaped plastic display (typically designed to hold printed sheets), but these plastic devices are relatively expensive and require the use of non-renewable resources.

The display of photographic prints is similarly problematic. In particular, in order to be displayed in an upright orientation, prints produced on photo paper by means of computers and printers require placement in a frame, such as a plastic frame with built-in brackets or feet.

Accordingly, there existed a need to provide a card design that overcomes one or more of these problems with prior cards and other display devices and/or that provides additional advantages. The embodiments described below can address this need, which has not heretofore been recognized and addressed. However, it should be recognized that the invention claimed herein is not limited to addressing any particular problem or set of problems, or to producing any particular benefit or set of benefits, except as set forth in the claims below.

According to one embodiment, a freestanding card can include a main display area. The card can also include a left leg extending away from a left side of a central lower portion of the card, and a right leg extending away from a right side of the central lower portion of the card. The card can be a unitary card including the main display area, the left leg, the right leg, and the central lower portion.

According to another embodiment, a card can include a main display area, a first separation line adjacent to the main display area, a first score extending from the first separation line, a second separation line adjacent to the main display area, and a second score extending from the second separation line. The first score and the second score can define a central lower portion therebetween that is below the main display area, the central lower portion extending between the first and second scores.

According to another embodiment, a card can include a first separation line and a first score extending from the first separation line, the first score and first separation line defining a first foldout leg. The card can also include a second separation line and a second score extending from the second separation line, the second score and second separation line defining a second foldout leg. In addition, the card can include a stationary leg between the first score and the second score. The card can be separated along the first and second separation lines. The first foldout leg can be pivoted about the first score and the second foldout leg can be pivoted about the second score. The card can be stood in a generally upright position with the card resting on a base that includes the stationary leg, the first foldout leg, and the second foldout leg.

According to yet another embodiment, a freestanding card can include a main display area and a base supporting the main display area and holding it in an upright position. The base can hold the main display area in a concavo-convex shape.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a front view of a display card according to a described embodiment with the legs in the flat position.

FIG. 2 is an isometric front view of the card of FIG. 1 with the legs in the standing position.

FIG. 3 is an isometric view similar to FIG. 2, but illustrating a design and text on the display card.

FIG. 4 is a side view of the card of FIGS. 1-3.

FIG. 5 is a rear isometric view of the card of FIGS. 1-4.

FIG. 6 is an isometric front view of another display card similar to the card of FIGS. 1-4, but in a portrait orientation, according to a described embodiment with the legs in the standing position.

FIG. 7 is a front view of another card according to a described embodiment with the legs in the flat position.

FIG. 8 is an isometric front view of the card of FIG. 7 with the legs in the standing position.

FIGS. 9, 10, 11 and 12 comprise a sequence demonstrating how to set up the card of FIGS. 7 and 8.

FIG. 13 is a side perspective view of the card of FIGS. 7-12

FIG. 14 is a rear isometric view of the card of FIGS. 7-13.

FIG. 15 is a front view of another display card according to a described embodiment, with the legs in the flat position.

FIG. 16 is a rear isometric view of the card of FIG. 15, with the legs in the standing position.

FIG. 17 is an overhead view of the card of FIGS. 15-16.

FIG. 18 is an overhead view of the card of FIGS. 15-17.

The description and drawings may refer to the same or similar features in different drawings with the same reference numbers.

### DETAILED DESCRIPTION

According to one embodiment, a freestanding card can include a main display area and a center leg extending down from the main display area, the center leg having a right side and an opposite left side. A left leg can extend back from the left side of the center leg, and a right leg can extend back from the right side of the center leg. The main display area can lean back over the left and right legs. Also, the main display area, the center leg, and the right leg can all be part of a unitary card.

According to another embodiment, a card can include a first separation line extending in from a first edge of the card, the separation line having an endpoint distal from the first edge. The card can also include a first score extending from the first separation line endpoint to a second edge of the card that is substantially perpendicular to the first edge. A second separation line can extend in from a third edge of the card that is substantially parallel to the first edge of the card, the second separation line having an endpoint distal from the third edge. A second score can extend from the second separation line endpoint to the second edge. The first score and the second score can define a central lower portion therebetween that extends between the first and second scores, and to the second edge of the card.

According to yet another embodiment, a card can be provided that includes a first separation line extending in from a first edge of the card, the separation line having an endpoint distal from the first edge. The card can also include a first score extending from the first separation line endpoint to a second edge of the card that is substantially perpendicular to the first edge, the first score and first separation line defining a first foldout leg. In addition, the card can include a second separation line extending in from a third edge of the card that is substantially parallel to the first edge of the card, the second separation line having an endpoint distal from the third edge. A second score can extend from the second separation line endpoint to the second edge of the card, the second score and second separation line defining a second foldout leg. The first score and the second score can also define a stationary leg therebetween. The card can be separated along the first separation line, and the first foldout leg can be pivoted about the first score. Likewise, the card can be separated along the second separation line, and the second foldout leg can be pivoted about the second score. Additionally, the card can be stood in a generally upright position with the card resting on the stationary leg, the first foldout leg, and the second foldout leg.

According to yet another embodiment, a freestanding card can include a main display area and a left leg that extends vertically back from the left edge of the card, and a right leg that extends vertically back from the right edge of the card. The left leg can be folded along two separate scores so that an insertion slit on its tip can be inserted into a slot in the bottom center of the card, thus forming a roughly quarter-pie-shaped left leg behind the card proper; likewise the right leg can be folded and inserted into the same slot, thus forming a complementary right support leg. At the line where the outer scores of the card's two legs meet, each leg can exert pressure against the other, thus forcing the right and left bottom corners of the card forward, away from the card's surface, and consequently bending the front of the card into a concave shape which serves as a kind of column, providing rigidity to the display area of the card.

As opposed to the concave or inward-bending structure of the card described in the preceding paragraph, an alternate embodiment of a card can derive rigidity from the formation of a convex or outward-bending shape. The right and left legs can be folded in the same manner as in the embodiment described in the preceding paragraph. However, instead of a slot along its bottom edge, this alternate embodiment can have a horizontal cut running slightly above and parallel to its bottom edge, so that a strip of material along the bottom can be pulled back from the front surface, allowing an insertion slit in the tip of each leg to be inserted into one of two vertical slits cut into the upper edge of this bottom strip, the net result being that the card attains rigidity from an outward bulge formed by the two tabs, which hold back the material below the horizontal slit, while they push forward the material above the horizontal slit.

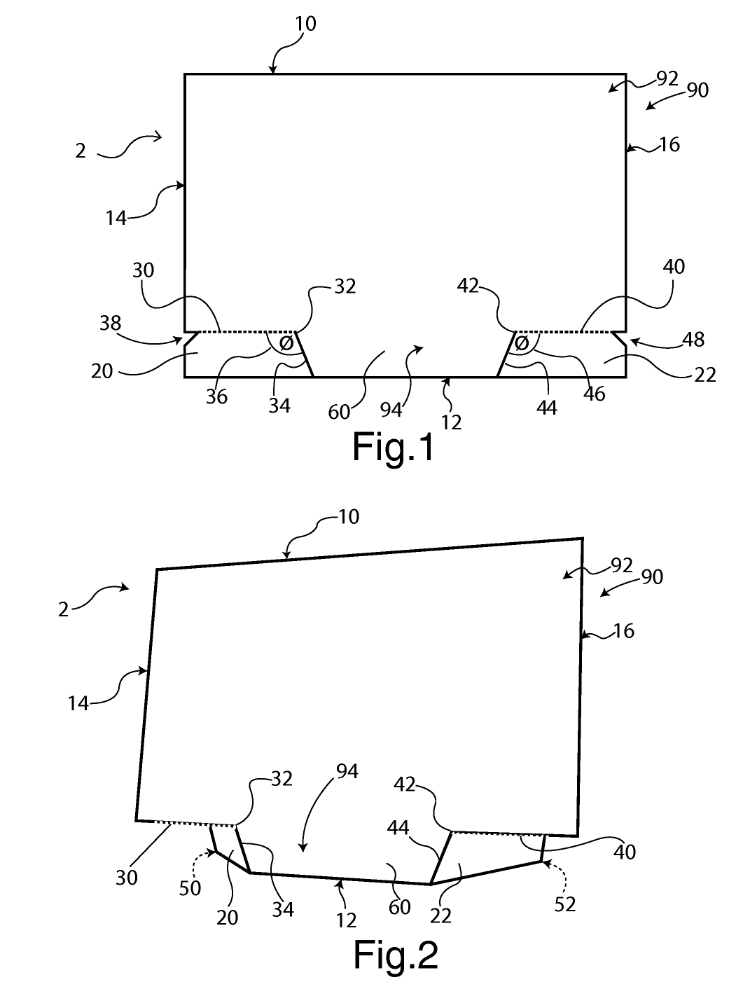

Referring to FIG. 1, a generally rectangular card (2) is illustrated in a flat position. The card (2) could be a standard postcard, or it could be any other type of flat display device made from a material that can be separated and folded along predetermined lines. The card (2) can have opposing top and bottom edges (10 and 12, respectively) extending horizontally, as well as opposing left and right (as viewed from the front) edges (14 and 16, respectively) extending vertically between the top and bottom edges (10, 12). The card (2) can include a left foldout leg (20) at the bottom left corner of the card (2) and a right foldout leg (22) at the bottom right corner of the card (2).

A left separation line, which can be a perforation line (30) or some other separation line such as a slit with a thin notch of connecting material, can be located near the bottom edge (12) of the card (2) and can extend from the left edge (14) of the card (2) toward the right edge (16) in a generally horizontal direction. The left perforation line (30) can terminate at a left intersection point (32), which can be located to the left of the center of the card (2). A left score (34) can slant down and to the right from the left intersection point (32) at a left score angle (36) from the horizontal direction. The left perforation line (30) and the left score (34) can thereby define the left foldout leg (20) below the left perforation line (30) and to the left of the left score (34).

The card (2) may define a left indentation (38) in the top of the left edge of the card's left foldout leg (20). The indentation (38) can be formed by cutting with a die or in some other manner. The indentation (38) may be triangular in shape as illustrated in FIG. 1. For example, for a standard size postcard, the indentation (38) can be a triangular shape that is about ¼ inch wide by ¼ inch deep. However, the indentation could be other shapes and sizes, and could be located in other locations near the left perforation line (30). For example, the indentation (38) could be formed from not only the leg (20), but also the area of the card (2) above the leg (20), or in some cases, only the area above the leg (20).

In a manner similar to the left separation line discussed above, a right separation line, which can be a perforation line (40), can be located near the bottom edge (12) of the card (2) and extends from the right edge (16) of the card (2) toward the left edge (14) in a generally horizontal direction. The right perforation line (40) can terminate at a right intersection point (42), which can be located to the right of the center of the card (2). A right score (44) can slant down and to the left from the right intersection point (42) at a right score angle (46) from the horizontal direction. The right perforation line (40) and the right score (44) can define the right foldout leg (22) below the right perforation line (40) and to the right of the right score (44).

The card (2) may define a right indentation (48) in the top of the right edge of the card's right leg (22). The indentation (48) can be formed by cutting with a die or in some other manner. The indentation (48) may be triangular in shape as illustrated in FIG. 1. For example, for a standard size postcard, the indentation (48) can measure about ¼ inch wide by ¼ inch deep. However, the indentation (48) could be other shapes and sizes, and could be located in other locations near the right perforation line (40). For example, the indentation (48) could be formed from not only the leg (22), but also the area above the leg (22), or in some cases, only the area above the leg (22).

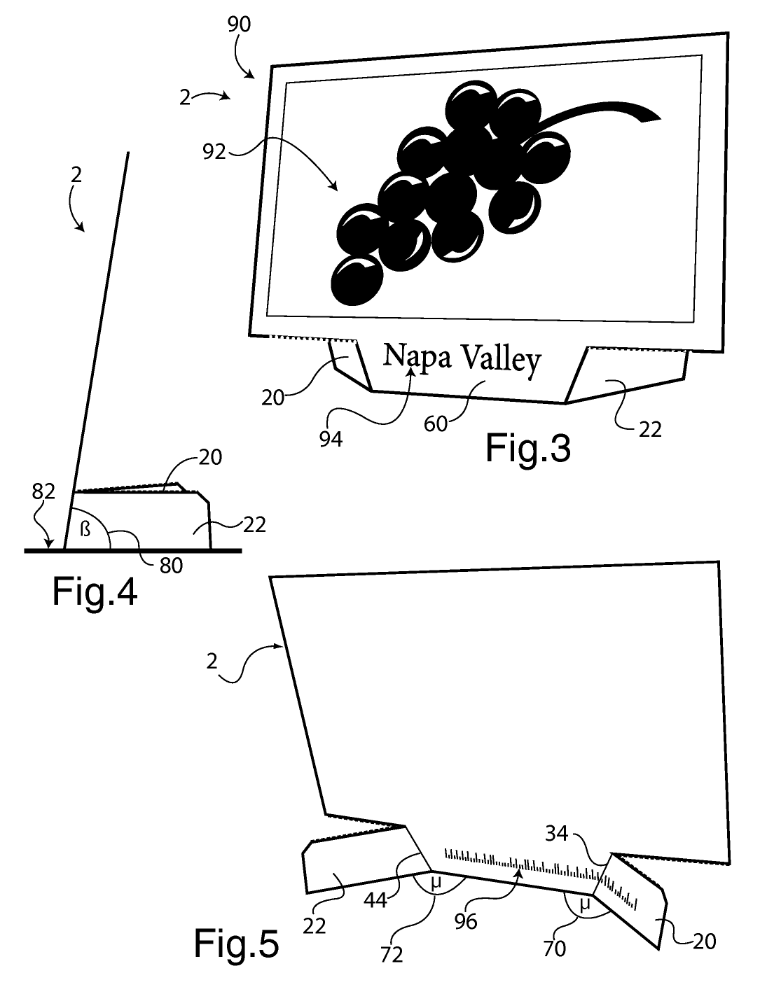

FIGS. 2-5 illustrate the card (2) in a standing position. This position can be formed by separating the card by tearing along the perforation lines (30, 40), and pivoting the foldout legs (20, 22) back around the respective scores (34, 44). This pivoting movement is illustrated by left leg pivot direction (50) and right leg pivot direction (52) in FIG. 2. This can result in the left leg (20) being folded out and the right leg (22) being folded out. It can also result in a lower central portion that forms a center stationary leg (60). The resulting freestanding card can easily stand on the three legs: the stationary leg (60), the left foldout leg (20), and the right foldout leg (22).

As noted above, the scores (34, 44) can extend at score angles (36, 46) relative to the horizontal direction. Those angles can be formed so that the main body of the card (2) will lean back while it is standing. This can result in the center of gravity of the card (2) being over the base formed by the bottom edges of the stationary leg (60) and the left and right legs (20, 22) when the card (2) is standing. Thus, the card (2) can be stable when it stands. The angles (36, 46) can be any angles that serve this purpose, such as from about 90 degrees to about 140 degrees, depending on the particular card. However, in one embodiment the score angles (36, 46) are each about 115 degrees.

As a user pulls back the legs (20, 22), the indentations (38, 48) can make it easier for the user to identify and grasp the outer parts of the legs (20, 22), and to tear along the perforation lines (30, 40). In addition, the indentations (38, 48) can impart a segmented silhouette to the card (2), which in turn can visually cue the user to the fact that the card includes foldout legs (20, 22).

The foldout legs (20, 22) can be pivoted so that the left bottom edge angle (70) between the bottom edge of the left leg (20) and the bottom edge of the stationary leg (60) in a horizontal plane is about 135 degrees, and so that the right bottom edge angle (72) between the bottom edge of the right leg (22) and the bottom edge of the stationary leg (60) in a horizontal plane is about 135 degrees. (See FIG. 5.) However, a user of the card (2) can determine how far to pivot the foldout legs (20, 22), and they may be pivoted at some other angle, such as 90 degrees or some other angle between 30 degrees and 150 degrees. As illustrated in FIG. 4, this can result in the card leaning back at an angle (80) between the main body of the card (2) and a horizontal surface (82) upon which the card (2) rests. That lean-back angle can be any angle that will allow the card to stay upright, but it can be from about 85 degrees to about 60 degrees, and in one embodiment it is about 77 degrees.

This arrangement can result in the freestanding card (2) having a substantially planar and generally upright display area (90) that includes a main display area (92) that is above the perforation lines (30, 40), as well as a lower display area (94) on the stationary leg (60) below the level of the perforation lines (30, 40), but between the scores (34, 44).

In the illustrated embodiment, a barcode area (96) can be located on the lower left back side of the card (2) (see FIG. 5, continuing to bear in mind that all references to left and right are from the point of view of the front of the card (2)). The aforementioned area (96) is typically used by the U.S. Postal Service for imprinting and scanning barcodes for sorting postcards. Specifically, the Postal Service's barcode is typically printed along the bottom of the back of the card so that the barcode's right-hand edge typically extends to a line that is 4.25 inches from the left edge (14) of the card (2). The illustrated embodiment may be configured so that, as shown, only one score (the left score (34)) and no perforation lines need be within the barcode area (96).

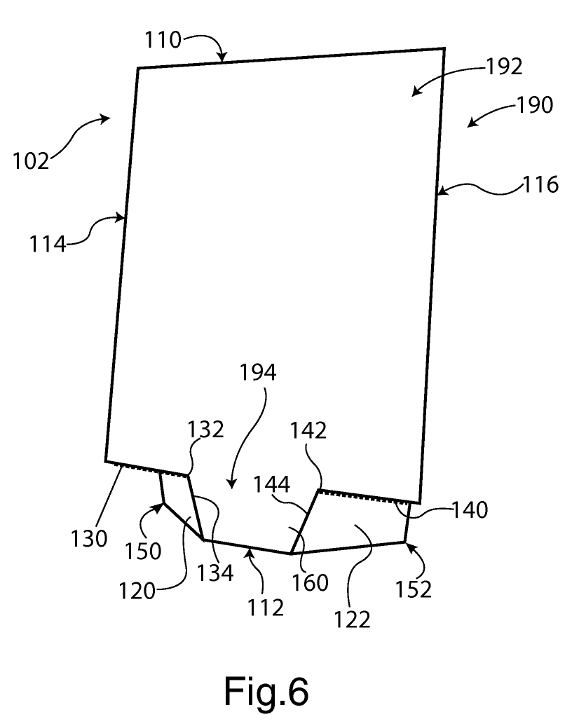

FIG. 6 illustrates another embodiment of a card (102), which can be similar to the card of FIGS. 1-5, but can include legs that are positioned for the card to stand in a portrait orientation rather than a landscape orientation. The reference numbers in FIG. 6 correspond to those above, but are higher by 100 (for example the left leg (120) in FIG. 6 corresponds to the left leg (20) in FIGS. 1-5).

The cards (2, 102) can be made from typical postcard material or any other generally flat material that can be perforated and folded, and that is sufficiently stiff to stand upright as shown in the figures and discussed above. For example, a card could be made of different types of cardstock, cardboard, or polymer materials. Furthermore, the card could serve a variety of purposes in addition to the conveyance of correspondence and sales messages, for example, an embodiment of the card could be applied to card-sized photo paper for home or office printers, so that the resulting photo paper could serve both as a surface for an image and also as a self-contained photo stand. As another example, the card in its alternate, vertical embodiment could serve as a freestanding version of the traditional sports and pop culture trading card. In addition, the card could be substantially larger or smaller than a standard postcard. Also, relative dimensions of the card could vary. For example, the relative lengths of the folding legs and the center leg or central lower portion could be varied.

This arrangement can produce substantial benefits that are not present in or predictable from prior freestanding cards. For example, in contrast to the prior devices for inserting pictures in freestanding displays that could be mailed, the card needs only a single layer (although it could have multiple layers) to be able to act as a freestanding display.

In addition, the manufacturing process for the cards described above can be simple. It can include standard card-making processes, including making perforations or slits along the indicated separation lines, making scores along the indicated scores, and die-cutting the indicated indentations. These are well-known manufacturing processes. The separation lines can be formed by die cutting a series of small holes in a surface to allow easy tearing along the line, or the separation lines can be formed in some other manner, such as by cutting a slit for each line and leaving a small, easily-tearable notch within the slit. A score can be formed by stamping a narrow crimp onto a surface, but it could be done by some other process that allows a flat material to be folded along a predetermined line. For example, a thin polymer sheet could be cast so that the material is thinner along the line where the fold is to be made. An indentation can be formed by cutting with an indentation-shaped section of a die, or some other process.

Furthermore, the above-mentioned simplicity of manufacture can allow the card to be produced as a “blank,” that is, a pre-cut, pre-scored, and pre-perforated but unprinted sheet, which can be configured with one or multiple cards per sheet, and which can be sized to be printed, such as on commercial sheet fed presses or common home/office printers.

Moreover, as compared to the cards described in the abstract and figures of the Pawlik Patent Document, the card described above provides several advantages. For example, both landscape and portrait embodiments of the Pawlik card are liable to problems in mailing. In the landscape embodiment of the Pawlik card, the design contains a vertical perforation at the center of the card. This is problematic because the U.S. Postal Service maintains a standardized automated sorting machine throughout its system, and this machine begins the sorting sequence by holding a card or letter against a wall by means of a bank of three spring-loaded plastic fingers, then grabbing the leading end of the card or letter with a high-speed rubber belt. Because the resulting tugging action exerts considerable force on the card or letter, the vertical perforation is susceptible to tearing.

Tearing of the perforation on the landscape Pawlik card could give rise to a related barcode problem. Because the vertical perforation sits squarely in the area where the U.S. Postal Service imprints its address-identifying barcode, a torn perforation could obscure part of the barcode, causing the card to be rejected and shunted to a special bin whose contents have to be hand-addressed. That hand addressing wastes the Postal Service's time and resources, and also delays the delivery of the card to the recipient. In addition, even if the perforation in the landscape embodiment of the Pawlik card is not torn, the mere presence of a perforation in the barcode-printing area of the card could present problems to the barcode-reading mechanism of the Postal Service's automated sorting machine.

The portrait embodiment of the Pawlik card is also liable to a sorting problem, which is the result of the die-cut slots near the edge of the card. The Postal Service's sorter contains infrared sensors that can interpret these slots as damaged areas or other anomalies, and the vertical card is thus liable to being shunted aside to the sorter's special bin for hand-addressing. As noted above, that can waste time and resources, and can delay delivery of the card.

Moreover, both the horizontal and vertical embodiments of the Pawlik card can create a problem for graphic designers. In the horizontal embodiment, this problem arises from the fact that the legs of the card swing out from the bottom center of the card. Thus, the legs necessarily preclude any printing on the bottom center of the card, which is the area most suitable for a caption to the main visual. In the vertical embodiment, the stand mechanism also precludes printing on the bottom center of the card. In both embodiments, a visually important section of the front of the card is sacrificed, which presents a problem of diminished visual impact not only to graphic designers, but also to printers, publishers, and users.

With the cards described above with reference to FIGS. 1-6, the scores, perforations, and indentations of a sheet of display material are configured so that the card can be set up in two easy main operations: folding back the left leg, and folding back the right leg. Moreover, the configuration requires only one score in the barcode-printing area of the card for the landscape embodiment, and additionally does not require vertical perforations near the center of the card. Furthermore, this configuration allows the additional display space on the stationary leg on the front of the card. It should be appreciated that the invention herein is not limited by the preceding distinction from the Pawlik patent or the benefits or advantages described herein.

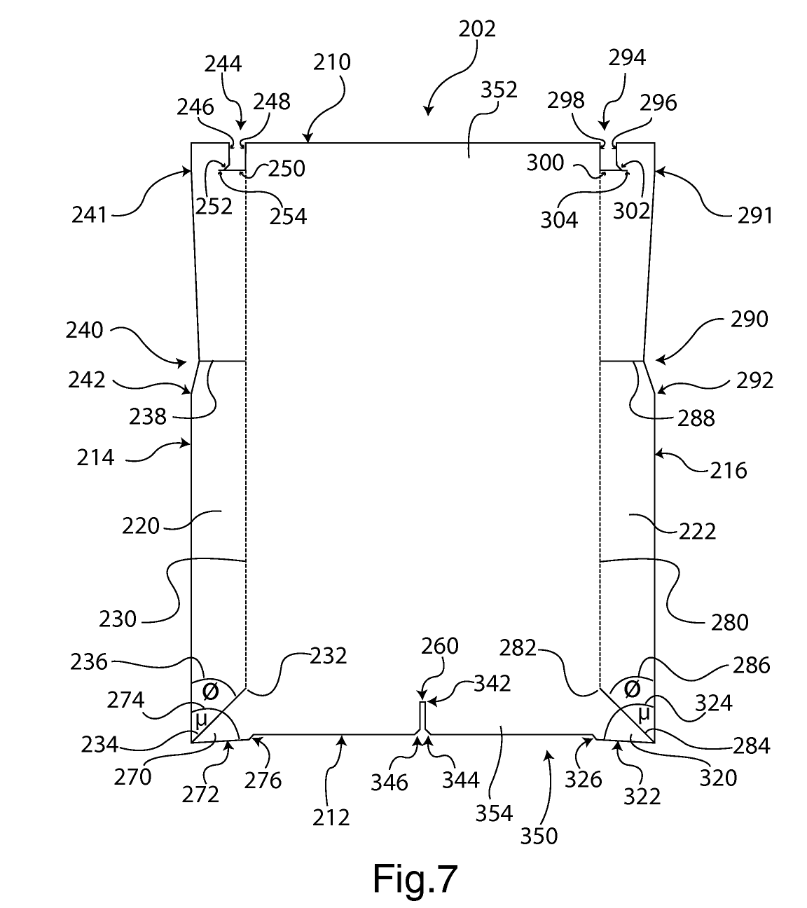

Referring to FIG. 7, another generally rectangular card (202) is illustrated in a flat position. As is the case with the cards (2, 102) of FIGS. 1-6, the card (202) could be any type of flat display device made from a material that can be separated and folded along predetermined lines. The card (202) can have opposing top and bottom edges (210 and 212, respectively) extending horizontally, as well as opposing left and right edges (214 and 216, respectively) extending vertically between the top and bottom edges (210, 212). The card (202) can include a left foldout leg (220) and a right foldout leg (222). These legs can extend vertically along most or all of the length of the left and right edges (214, 216) of the card (202).

A left separation line (230), which can take different forms, such as a perforation line or a slit, can run parallel to the left edge (214) of the card (202), extending from near the top edge (210) of the card to a left intersection point (232) near the bottom edge (212) of the card. A left lower score (234) can slant down and to the left from the left intersection point (232) at a left score angle (236) from the vertical direction. For example, the left score angle (236) can be about 45 degrees or some other suitable angle. The left separation line (230) and the left lower score (234) can thereby define the left foldout leg (220) to the left of the left separation line (230) and above the left lower score (234).

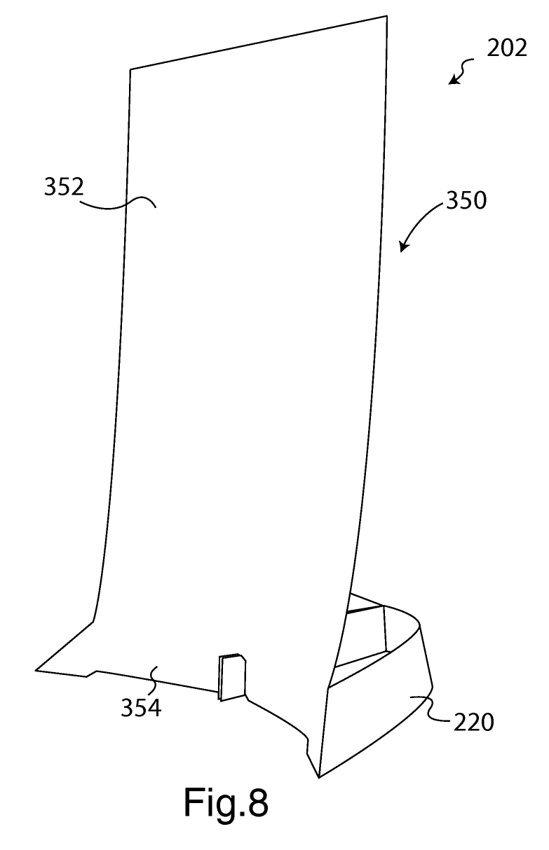

An upper left score (238) can extend across the left leg (220). The upper left score (238) may be slanted, or, as illustrated, parallel to the top and bottom edges (210 and 212, respectively) of the card (202). The upper left score (238) can be generally located in the upper left part of the card (202), extending from the left edge (214) of the card (202) to the left separation line (230). The upper left score (238) can thus define an edge at which, when the card (202) is set up as illustrated in FIGS. 8, 13, and 14, the lower part of the left leg (220) (extending away from the front surface of the card) transitions into the upper part of the left leg (220) (returning to the card), both parts of the left leg (220) thus forming part of a base behind the display area of the card.

A left indentation (240) on the left edge of the left leg (220) can be formed by an angled cut that extends from a point (241) above the upper score (238) in and down to the upper score (238), and then out and down to a point (242) below the upper score (238).

A left insertion tab (244) at the top end of the left leg can be formed by an outer cut (246) extending down from the top edge of the left leg (220), an inner cut (248) extending generally parallel to the outer cut (246) in line with the left separation line (230), a lower cut (250) extending to the left from the bottom of the inner cut (248), and a slanted cut (252) that slants down and to the left from the bottom of the outer cut (246) to meet the lower cut (250). The lower cut (250) can extend to the left beyond the slanted cut (252) to form a slit (254). During setup of the card (202), the slit (254) can push into and grip the material above a slot (260) extending up from the bottom edge (212) of the card (202). Accordingly, the slot (260) can act as an attachment point for the free end (i.e., an end that is not permanently attached) of the left leg (220).

A left foot (270) at the bottom of the left side of the card (202) can take its shape from a slanting cut (272), which can extend from a lower left corner of the card (202) at a cut angle (274) from a vertical portion of the left edge (214); a slanting cut (276), which can extend up from the right end of the cut (272) parallel to the left lower score (234); the left lower score (234); and the bottom edge (212) of the card (202). The cut angle (274) can be a range of angles, such as an angle that is from about 85 degrees to about 90 degrees. In one example, the cut angle (274) can be about 88 degrees.

In a manner similar to the left separation line (230) of the card (202) described above, a right separation line (280), which can take various forms such as a perforation line or a slit, can run parallel to the right edge (216) of the card (202), extending from near the top edge (210) of the card to a right intersection point (282) near the bottom edge (212) of the card. A right lower score (284) can slant down and to the right from the right intersection point (282) at a right score angle (286) from the vertical direction. For example, the right score angle (286) can be about 45 degrees or some other suitable angle. The right separation line (280) and the right lower score (284) can thereby define the right foldout leg (222) to the right of the right separation line (280) and above the right lower score (284).

In continuing reference to the card (202) and FIG. 7, an upper right score (288) can extend across the right leg (222). The upper right score (288) may be slanted, or, as illustrated, parallel to the top and bottom edges (210 and 212, respectively) of the card (202). The upper right score (288) can be generally located in the upper part of the card (202), extending from the right edge (216) of the card (202) to the right separation line (280). The upper right score (288) can thus define an edge at which, when the card (202) is set up, a lower part of the right leg (222) (extending away from the front surface of the card) transitions into an upper part of the right leg (222) (returning to the card), both parts of the right leg (222) thus forming part of a base behind the display area of the card (202).

A right indentation (290) on the right edge of the right leg (222) can be formed by an angled cut that extends from a point (291) above the upper right score (288) in and down to the upper right score (288), and then out and down to a point (292) below the upper right score (288).

A right insertion tab (294) at the top end of the right leg can be formed by an outer cut (296) extending down from the top edge of the right leg (222), an inner cut (298) extending generally parallel to the outer cut (296) in line with the right separation line (280), a lower cut (300) extending to the right from the bottom of the inner cut (298), and a slanted cut (302) that slants down and to the right from the bottom of the outer cut (296) to meet the lower cut (300). The lower cut (300) can extend to the right beyond the slanted cut (302) to form a slit (304). During setup of the card (202), the slit (304) can push into and grip the material above the slot (260). Accordingly, the slot (260) can act as an attachment point for the free end of the right leg (222).

A right foot (320) at the bottom of the right side of the card (202) can take its shape from a slanting cut (322), which can extend from a lower right corner of the card (202) at a cut angle (324) from a vertical portion of the right edge (216); a slanting cut (326), which can extend up from the right end of the cut (272) parallel to the right lower score (284); the right lower score (284); and the bottom edge (212) of the card (202). The cut angle (324) can be a range of angles, such as an angle that is from about 85 degrees to about 90 degrees. In one example, the cut angle (274) can be about 88 degrees.

A slot (260) can extend up from the bottom edge (212) to an end (342) of the slot (260) distal from the bottom edge (212). A right slanting cut (344) and a left slanting cut (346) can widen the slot (260) as it opens at the bottom edge (212) of the card (202).

Accordingly, the card (202) can include a display portion (350) that includes a main display portion (352), as well as a lower display portion (354). The lower display portion (354) can be the central lower portion of the card (202), and can include the portion between the left lower score (234) and the right lower score (284). As can be seen in FIG. 8, the lower display portion (354) can form a center leg that, together with the left leg (220) and right leg (222), forms a supporting base for the card (202).

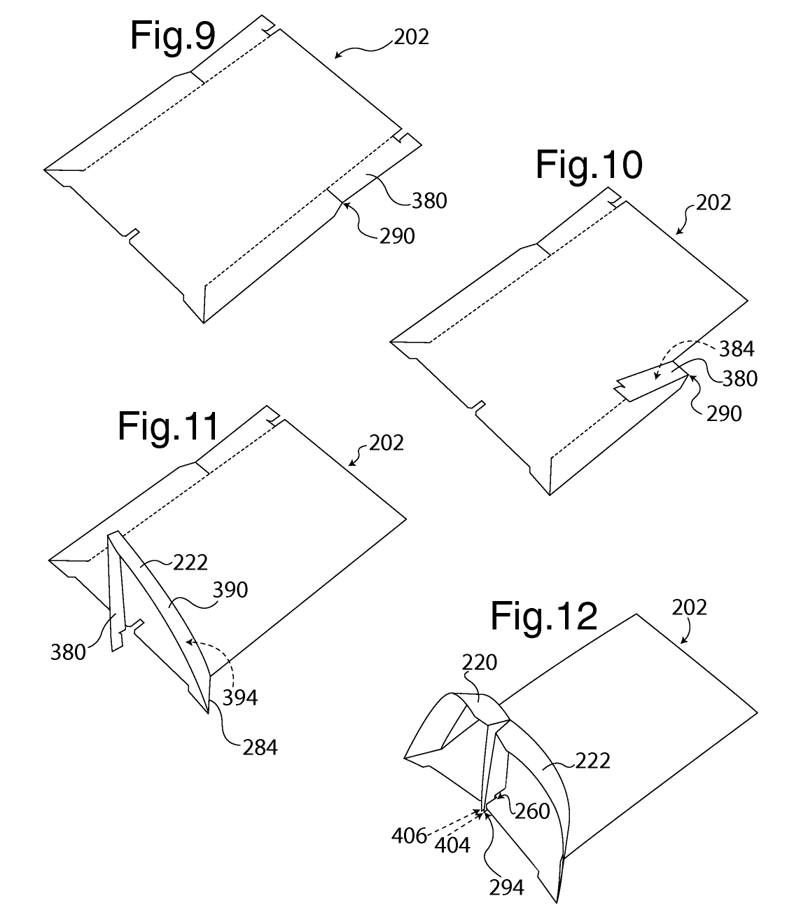

As noted above, FIG. 8 illustrates the card (202) in a standing position. This position can be formed by the technique illustrated by FIGS. 9-12, in which the card (202) is shown lying face down. The illustrated technique can begin by separating and folding the right leg (222) (as viewed from the rear), although the setup technique can begin with either leg. Also, the setup technique can differ in sequence and in other respects as well. In this example, setup can begin by pivoting the upper section (380) of the right leg (222) around the upper right score (288). This pivoting movement is illustrated in FIG. 10 by an upper right leg pivot direction (384). In the next stage of the setup technique, as illustrated in FIG. 11, the lower section (390) of the right leg (222) can be pivoted around the right lower score (284). This pivoting movement is illustrated by lower right leg pivot direction (394). In the subsequent stage of the setup process as shown in FIG. 12, the pivoting actions illustrated in FIGS. 10 and 11 can be repeated for the left leg (220). Also in this stage, as illustrated by an insertion direction (404), the right insertion tab (294) can be pushed into the slot (260) until the right insertion tab slit (304, as seen in FIG. 7) fits snugly against the upper edge of the slot (260, as seen in FIG. 7). This insertion action can be repeated for the left leg (220), as illustrated in FIG. 12 by insertion direction (406). The card (202) can then be positioned with the left leg (220), the right leg (222) and the lower display portion (354) forming a base that can rest on a surface and support the display portion (350) of the card (202) in a generally upright position.

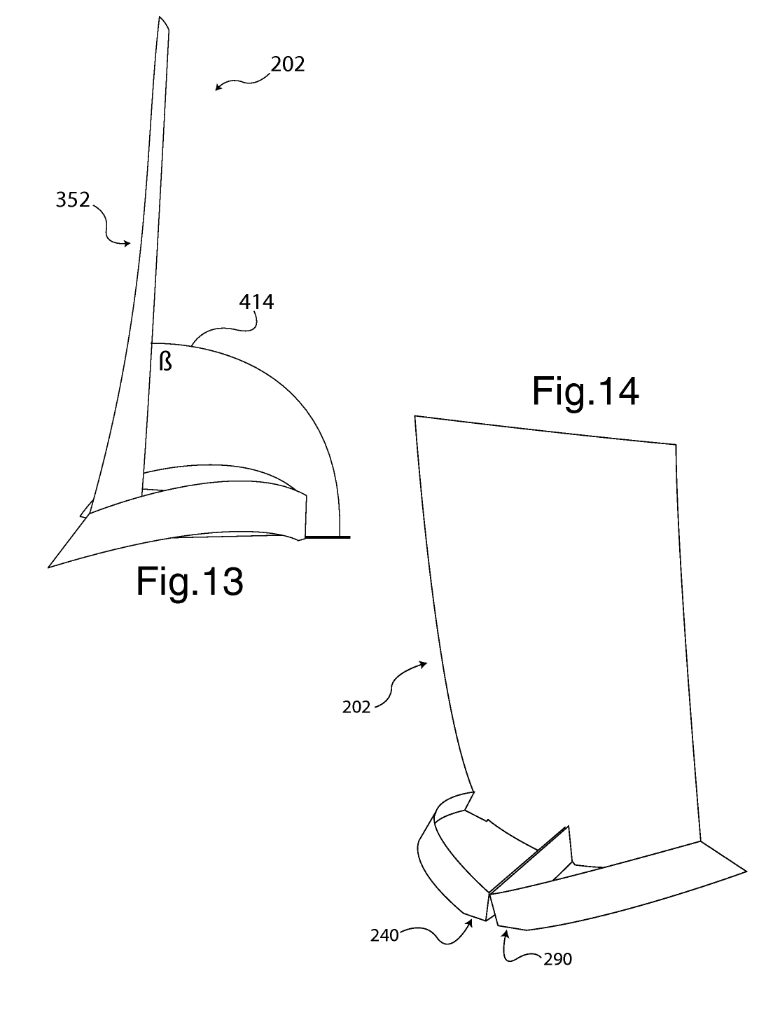

As illustrated in FIG. 13, when the card (202) is set up and standing, its main display portion (352) can lean slightly back at an angle (414), so that the center of gravity of the card is over the base formed by the right leg (222), the left leg (220) and the lower display portion (354) (which can form a center leg). This tilt can be produced by the overall structure of the card (202), which can include the following indentations: first, as illustrated in FIG. 7, the bottom edge (212) of the card, which can be slightly recessed between the feet (270 and 320); second, as also noted above and illustrated in FIG. 7, indentations at the left and right edges (214 and 216, respectively) of the left and right legs (220 and 222, respectively).

Furthermore, as illustrated in FIG. 14, when the card (202) is set up and standing, the lower sections of the leg indentations (240 and 290) (the sections below the upper scores (238 and 288) in FIG. 7) can produce a flat edge that can rest flush on a flat surface that is supporting the card (202), thereby adding stability to the card (202).

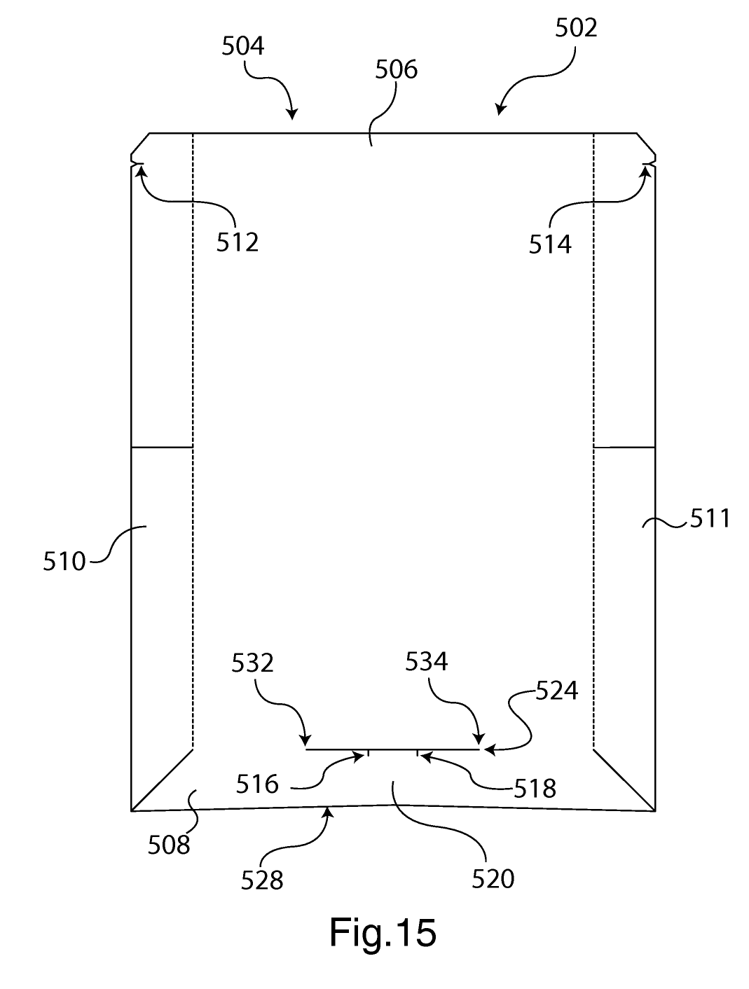

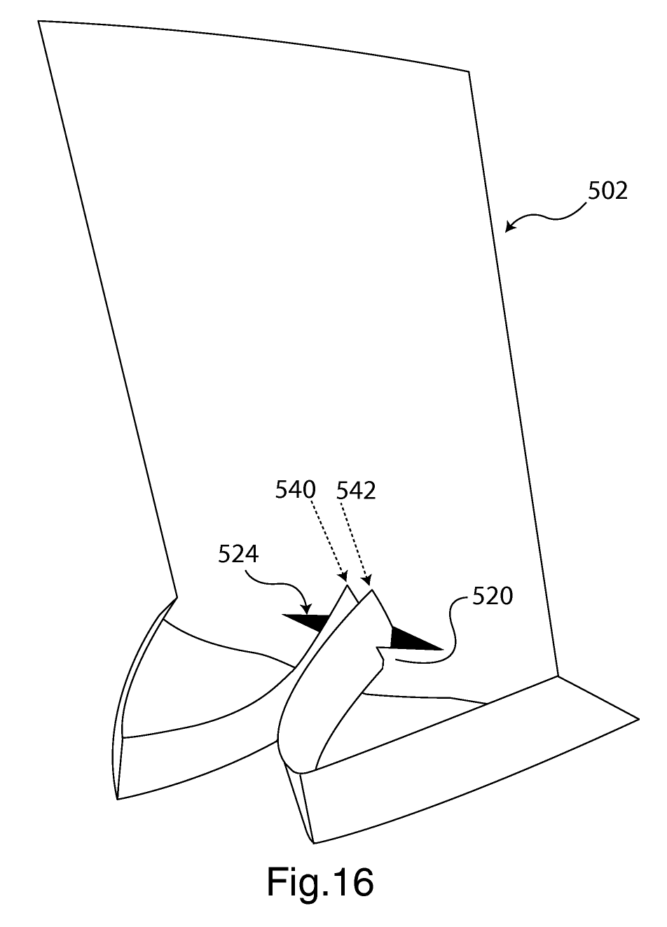

FIG. 15 illustrates an alternate embodiment of a card (502). This card (502) can be similar to the card (202) in FIGS. 7-14. The card (502) can include a display portion (504), which can include a main display portion (506) and a lower display portion (508), similar to the card (202) of FIGS. 7-14. The card (502) can also include a left leg (510) and a right leg (511), similar to the card (202) of FIGS. 7-14. The card (502) can also define left and right insertion tab slits (512 and 514) extending in from outside edges of the left and right legs, respectively, as shown in FIG. 15. The slits (512 and 514) do not attach to a single slot (such as the slot (260) in FIG. 7), but instead can attach to slits (516 and 518, in FIG. 15) cut into an upper edge of a bendable strip (520) centrally located in the lower display portion (508). The bendable strip (520) can be bounded on its top edge by a cut (524), on its bottom edge by a bottom edge (528) of the card (502), on its left by a vertical transition area extending from a left end (532) of the cut (524) to the bottom edge (528) of the card (502), and on its right by a vertical transition area extending from a right end (534) of the cut (524) to the bottom edge (528) of the card (502).

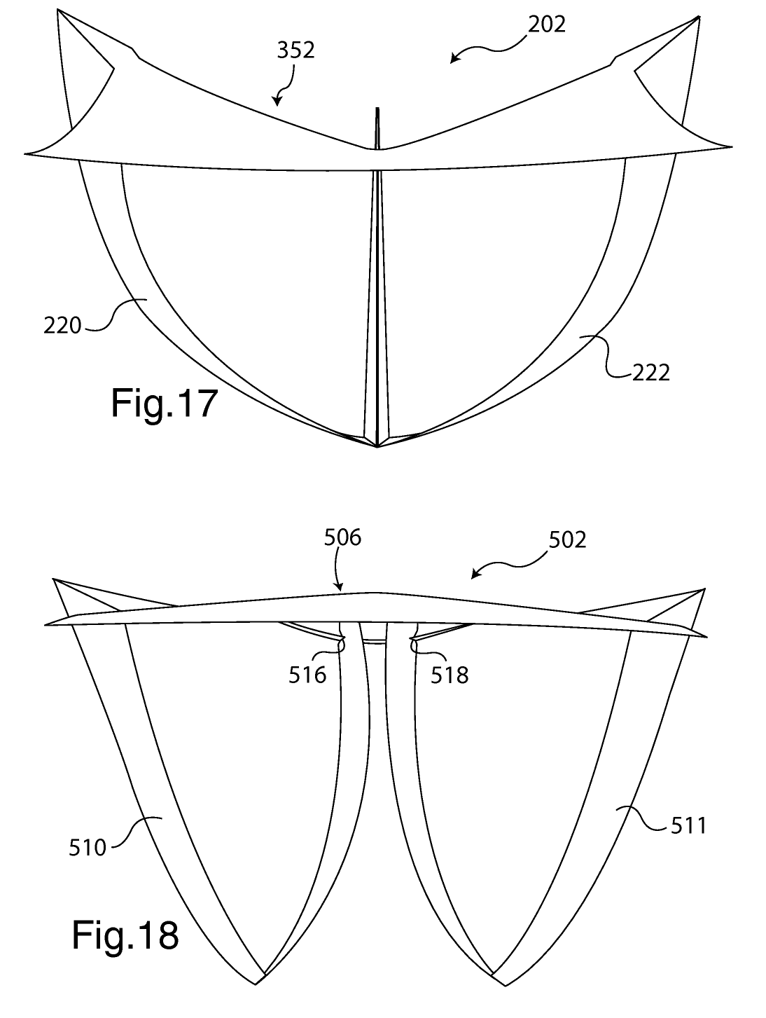

The setup technique for the card (502) can be similar to the setup technique described above for the card (202) of FIGS. 7-14. The left leg (510) and the right leg (511) of the card (502) can be bent as described above with reference to the card (202) of FIGS. 7-14. As illustrated in FIG. 16 by insertion directions (540 and 542), the insertion tab slits (512 and 514) can be slid into a mating relationship with the slits (516 and 518) in the bendable strip (520). In this position, the ends of the legs (510 and 511) can force the center of the main display portion (506) forward, so that the main display portion (506) can form a concavo-convex shape, with the front surface of the card (502) being convex. In contrast, as is illustrated in FIG. 17, a central portion of the main display portion (352) of the card (202) of FIGS. 7-14 can be pulled back by the legs (220, 222), so that the main display portion (352) forms a concavo-convex shape, with the front surface of the card (202) being concave. For both cards (202 and 502), the concavo-convex shape can be concavo-convex about an axis that extends upwardly so that side edges of the cards (202 and 502) are forward or rearward of central regions of the cards. For both cards (202 and 502), the concavo-convex shape can increase the rigidity of the main display portion (352 or 506) to help prevent the main display portion (352 or 506) from bending forward or backward when in the standing position.

All the cards described above can be made of different types of cardstock, cardboard, polymer materials, or indeed any generally flat material that can be perforated and folded, and that is sufficiently stiff to stand upright as shown in the figures and discussed above. The cards (202 and 502) of FIGS. 7-18 may not be optimally configured to be sent by mail. However, those cards (202 and 502) may be used for a variety of other purposes in addition to the display of point-of-sale information, and in addition, the cards (202 and 502) could be substantially larger or smaller than a standard United States letter-sized or A4-sized card.

This arrangement can produce substantial benefits that are not present in or predictable from prior freestanding countertop display systems. For example, in contrast to a system consisting of a printed card affixed to an easel back, the cards of FIGS. 7-14 can be manufactured as unitary “blanks,” then printed and distributed, so that both the message carrier and its support are contained within a single device, thus reducing both labor and cost.

Furthermore, the cards of FIGS. 7-18 can offer the same manufacturing advantages previously described for the cards of FIGS. 1-6. The cards of FIGS. 7-18 can include many variations from the particular embodiments described above and illustrated in FIGS. 7-18. For example, the angle (236 or 286, as illustrated in FIG. 7) of the lower scores (234 and 284, as also illustrated in FIG. 7) could be substantially greater or lesser than the 45-degree angle indicated. As another example, the separation lines for forming the legs could be formed either by complete cuts, or by cuts with a series of small connecting bridges, or by some technique other than perforations. As an additional example, a slanting third score could be added near the bottom score of each leg, in order to allow the entire leg to rest flush against a supporting surface. As yet another example, the top of the card could be die cut according to a fanciful graphic design that reinforced the message, for instance, for a ski resort the die cut could suggest mountains.

Accordingly, while the invention has been particularly shown and described with reference to embodiments thereof, it will be understood by those skilled in the art that various changes in form and details may be made therein without departing from the spirit and scope of the invention. For example, the perforation lines could slant at some direction other than horizontal or vertical. As another example, the cards could be embodied with or without indentations.

I claim:

1. A freestanding card comprising:
a main display area;
a central lower portion of the card below the main display area;
a left leg extending away from a left side of the central lower portion of the card; and
a right leg extending away from a right side of the central lower portion of the card;
wherein the card is a unitary card comprising the main display area, the left leg, the right leg, and the central lower portion.

2. The card of claim 1, wherein the main display area forms a concavo-convex curvature.

3. The card of claim 1, wherein the central lower portion forms a center leg.

4. The card of claim 1, wherein the central lower portion comprises a right foot and a left foot.

5. The card of claim 1, wherein the left leg and the right leg extend back from the central lower portion.

6. The card of claim 1, wherein:
the left leg extends back and away from the central lower portion without returning to an attachment point on the card, the left leg forming a left part of a base that supports the card; and
the right leg extends back and away from the central lower portion without returning to an attachment point on the card, the right leg forming a right part of the base.

7. The card of claim 1, wherein:
the left leg extends back and away from the central lower portion and then attaches to an attachment point on the card, the left leg forming a left part of a base; and
the right leg extends back and away from the central lower portion and then attaches to an attachment point on the card, thereby forming a right part of the base.

8. The card of claim 7, wherein the left leg extends back and away from the central lower portion and then returns to an attachment point on the card, and wherein the right leg extends back and away from the central lower portion and then returns to an attachment point on the card.

9. The card of claim 1, wherein the central lower portion comprises a front part of the base.

10. The card of claim 1, wherein the main display area leans back at an angle of from about 85 degrees to about 60 degrees relative to a horizontal plane.

11. The card of claim 1, wherein the main display area and the central lower portion are substantially coplanar.

12. The card of claim 1, wherein the card is a postcard.

13. The card of claim 1, wherein the right side of the central lower portion comprises a score that pivotally joins the central lower portion and the right leg, and the left side of the central lower portion comprises a score that pivotally joins the central lower portion and the left leg.

14. A card comprising:
a main display area;
a first separation line adjacent to the main display area;
a first score extending from the first separation line;
a second separation line adjacent to the main display area; and
a second score extending from the second separation line;
wherein the first score and the second score define a central lower portion therebetween that is below the main display area, the central lower portion extending between the first and second scores.

15. The card of claim 14, wherein the first separation line and the second separation line are substantially parallel.

16. The card of claim 14, wherein:
the first separation line extends in from a first edge of the card, the first separation line having an endpoint distal from the first edge;
the first score extends from the endpoint of the first separation line to a second edge of the card that is substantially perpendicular to the first edge;
the second separation line extends in from a third edge of the card that is substantially parallel to the first edge of the card, the second separation line having an endpoint distal from the third edge;
the second score extends from the endpoint of the second separation line to the second edge.

17. The card of claim 16, wherein the first and second separation lines are substantially parallel to the second edge.

18. The card of claim 16, wherein the first score forms an angle of from about 90 degrees to about 140 degrees relative to the second edge.

19. The card of claim 16, wherein the first score forms an angle of about 115 degrees relative to the second edge.

20. The card of claim 16, wherein the card defines a first indentation extending in from the first edge of the card adjacent to the first separation line.

21. The card of claim 20, wherein the card defines a second indentation extending in from the third edge of the card adjacent to the second separation line.

22. The card of claim 14, wherein the card is a postcard.

23. The card of claim 14, wherein:
the first separation line and the first score define a first leg portion extending along a first edge of the card;
the central lower portion extends along a second edge of the card that is substantially perpendicular to the first edge; and
the second separation line and the second score define a second leg portion extending along a third edge of the card that is substantially parallel to the first edge.

24. The card of claim 23, wherein the first leg comprises a score extending across the first leg, and the second leg comprises a score extending across the second leg.

25. The card of claim 23, wherein the card comprises an attachment point for a free end of the first leg and an attachment point for a free end of the second leg.

26. A method of forming a freestanding card, the method comprising:
providing a card comprising:
a first separation line;
a first score extending from the first separation line, the first score and first separation line defining a first foldout leg;
a second separation line;
a second score extending from the second separation line, the second score and second separation line defining a second foldout leg; and
a stationary leg between the first score and the second score;
separating the card along the first separation line;
pivoting the first foldout leg about the first score;
separating the card along the second separation line;
pivoting the second foldout leg about the second score; and
standing the card in a generally upright position with the card resting on a base that comprises the stationary leg, the first foldout leg, and the second foldout leg.

27. The method of claim 26, further comprising:
pivoting a portion of the first foldout leg about a third score that extends across the first foldout leg; and
pivoting a portion of the second foldout leg about a fourth score that extends across the second foldout leg.

28. The method of claim 27, further comprising:
attaching an end of the first foldout leg to a central attachment point on the stationary leg; and
attaching an end of the second foldout leg to a central attachment point on the stationary leg.

29. The method of claim 26, wherein pivoting the first foldout leg along the first score comprises pivoting the first foldout leg until a bottom edge of the first foldout leg is at an angle of from about 30 to about 150 degrees relative to a bottom edge of the stationary leg.

30. The method of claim 26, wherein pivoting the first foldout leg along the first score comprises pivoting the first foldout leg until the bottom edge of the first foldout leg is at an angle of about 135 degrees relative to the bottom edge of the stationary leg.

31. The method of claim 26, wherein standing the card in a generally upright position comprises standing the card so that a main display area of the card leans back toward the first and second foldout legs.

32. The method of claim 26, wherein standing the card in a generally upright position comprises standing the card so that the stationary leg is substantially coplanar with the main display area.

33. The method of claim 26, wherein standing the card in a generally upright position comprises standing the card so that a main display area of the card is in a portrait orientation.

34. The method of claim 26, wherein standing the card in a generally upright position comprises standing the card so that a main display area of the card is in a landscape orientation.

35. The method of claim 26, further comprising attaching a free end of the first foldout leg to an attachment point on the card, and attaching a free end of the second foldout leg to an attachment point on the card.

36. A freestanding card comprising:
a main display area;
a base supporting the main display area and holding the main display area in an upright position, the base holding the main display area in a concavo-convex shape.

37. The card of claim 36, wherein the concavo-convex shape is concavo-convex about an axis that extends upwardly.

38. The card of claim 36, wherein the card is a unitary card that includes the base and the main display area.

39. The card of claim 36, wherein the base includes a left leg, a right leg, and a central lower portion of the card.

40. The card of claim 36, wherein the left leg extends out from a left side of the central lower portion and the right leg extends out from a right side of the central lower portion.

41. The card of claim 40, wherein:
the left leg extends back from the left side of the central lower portion and then forward to a central attachment point on the central lower portion; and
the right leg extends back from the right side of the central lower portion and then forward to a central attachment point on the central lower portion.
